(19) United States
(12) Patent Application Publication
(10) Pub. No.: US 2003/0169011 A1
(43) Pub. Date: Sep. 11, 2003

(54) Drive method of stepping motor

(75) Inventor: Fusao Hori, Tagata-gun (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Toshiba Tec Kabushiki Kaisha, Tokyo (JP)

(21) Appl. No.: 10/093,761

(22) Filed: Mar. 8, 2002

(51) Int. Cl. H02P 8/00

(52) U.S. Cl. 318/696

(57) ABSTRACT

A stepping motor remains subjected to a micro step driving sequence having a plurality of divided phases, until the rotation speed of the rotor increases to a specific speed after the start of rotation. When the speed increases to the specific speed, the motor is switched to 1-2 phase excitation rotating/driving.

### BACKGROUND OF THE INVENTION

1. Field of the Invention

The present invention relates to a drive method for a stepping motor.

2. Description of the Related Art

For control of a stepping motor, an open loop control is more often used than closed loop control which is expensive.

In open loop control, a motor is controlled without detecting a deviation amount of an electric angle and mechanical angle. Therefore, the deviation amount of the electric angle and mechanical angle increases.

When the deviation amount increases, the next step command comes before one step is completed, and a so-called out-of-step phenomenon occurs.

The deviation amount of the electric angle and mechanical angle increases, when the motor rotates at a low speed, for example, when the motor is started or decelerated and stopped, or when the motor rotates at a high constant speed.

Example of causes of increases in the deviation amount of the electric angle and mechanical angle during the starting of the motor are a shortage of a step response time and a damping.

For a stepping motor, when the step response time comes short, the rotation of a rotor cannot catch up with the progress of the step command.

A stepping motor is controlled so as to suppress the damping. However, when damping increases, the deviation amount of the electric angle and mechanical angle increases.

Moreover, an example of one cause of increases in the deviation amount of the electric angle and mechanical angle during constant-speed rotation of the motor is sufficient basic torque. When a torque shortage occurs, the deviation amount of the electric angle and mechanical angle increases.

Furthermore, a control called “micro step driving” is known as a control of a stepping motor.

In micro step driving, an interval between one step and the next step by phase switching of the stepping motor is more finely controlled, and this driving is used to enhance position precision.

For example, in Jpn. Pat. Appln. KOKAI Publication No. 10-334474, it is described that one portion of the motor is driven by a micro step during the rotation at a high constant speed, and the motor is controlled with a high position precision.

However, the torque generated during micro step driving of the stepping motor is smaller than the torque generated during 2-phase or 1-2 phase excitation driving of the stepping motor.

Therefore, during micro step driving, the stepping motor easily becomes out-of-step, compared with 2-phase or 1-2 phase excitation driving.

In the present invention, the deviation amount of the electric angle and mechanical angle is prevented from increasing and the out-of-step is prevented from occurring when the motor is started or when the motor is decelerated and stopped. Moreover, the deviation amount of the electric angle and mechanical angle is also prevented from increasing and the out-of-step is prevented from occurring, even when the motor rotates at a constant speed. Additionally, cost increase is suppressed.

### BRIEF SUMMARY OF THE INVENTION

A stepping motor according to the present invention, a rotor is rotated/driven by a micro step in accordance with a micro step driving sequence with a plurality of divided phases until a rise of a rotation speed to a specific speed from rotation start. Moreover, when the rotation speed rises to the specific speed, the sequence is switched to a phase excitation sequence and the rotor is rotated/driven.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently embodiments of the invention, and together with the general description given above and the detailed description of the embodiments given below, serve to explain the principles of the invention.

FIG. 1 is a block diagram showing a structure of a stepping motor driving portion according to one embodiment.

FIG. 2 is a diagram showing phase signals, when the stepping motor is rotated at a constant speed by 1-2 phase excitation in the embodiment.

FIG. 3 is a diagram showing the phase signals, when the stepping motor is shifted to 1-2 phase excitation driving from micro step driving in the embodiment.

FIG. 4 is a diagram showing the phase signals, when the stepping motor is shifted to micro step driving from 1-2 phase excitation driving in the embodiment.

FIG. 5 is a diagram showing the phase signals, when the stepping motor rotates at a constant speed by 2-phase excitation according to another embodiment.

FIG. 6 is a diagram showing the phase signals, when the stepping motor is shifted to the 2-phase excitation driving from the micro step driving in the embodiment.

FIG. 7 is a diagram showing the phase signals, when the stepping motor is shifted to micro step driving from 2-phase excitation driving in the embodiment.

### DETAILED DESCRIPTION OF THE INVENTION

One embodiment of the present invention will be described hereinafter with reference to the drawings.

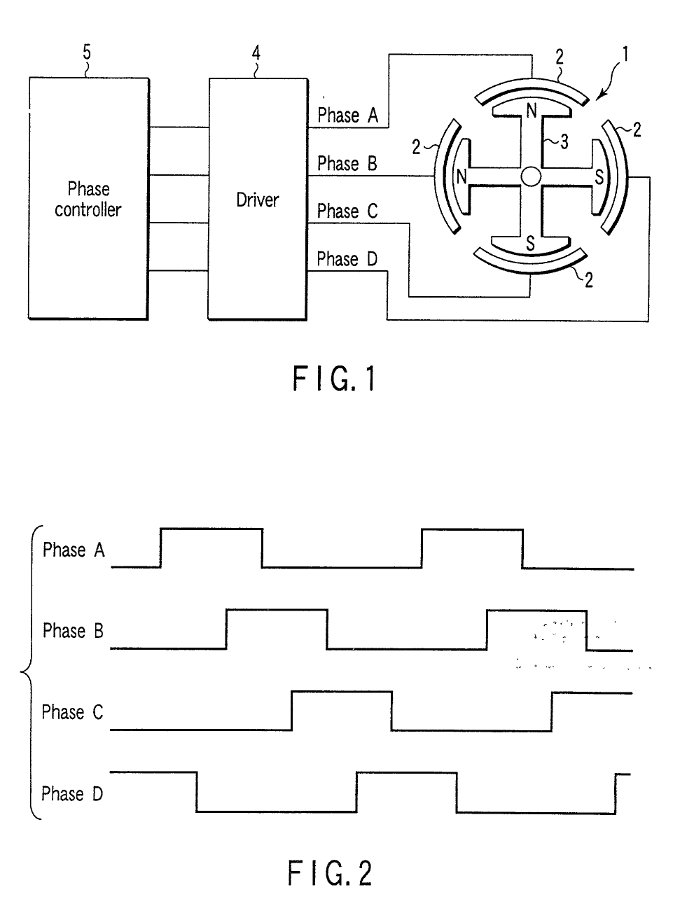

FIG. 1 is a block diagram showing a structure of a stepping motor driving portion.

In a stepping motor 1, stator coils 2 are wound around respective poles of a stator constructed of four poles.

A rotor 3 constructed of four poles is rotatably disposed in the stator.

For the stepping motor 1, a driver 4 supplies phase signals of phases A, B, C, and D to the stator coils 2.

The driver 4 outputs the respective phase signals in response to a signal from a phase controller 5.

When the stepping motor 1 rotates at a constant speed, the driver 4 outputs the phase signals of the phases A, B, C, and D with timings shown in FIG. 2 and the stepping motor 1 is subjected to 1-2 phase excitation driving.

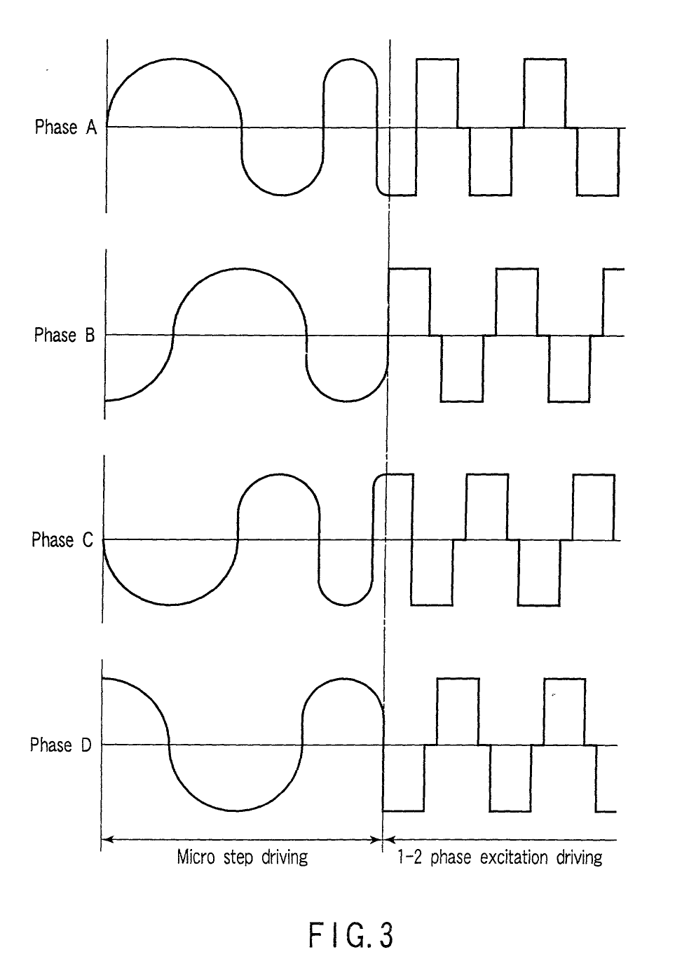

When the stepping motor 1 is started, as shown in FIG. 3, the driver 4 first performs micro step driving. Subsequently, when the rotation speed of the rotor 3 rises to a specific speed, the driving is switched to 1-2 phase excitation driving.

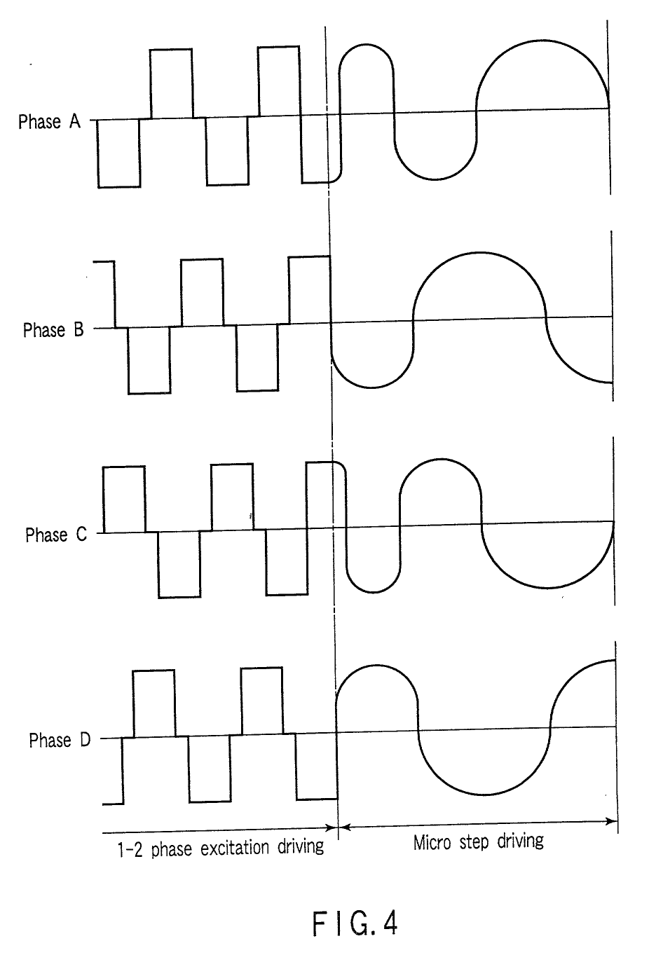

The constant speed of the stepping motor 1 is reduced, and the motor is stopped. In this case, as shown in FIG. 4, the driver 4 performs 1-2 phase excitation driving, until the rotation speed of the rotor 3 is reduced to a specific speed. Subsequently, when the rotation speed of the rotor 3 is reduced to the specific speed, driving is switched to micro step driving.

The phase controller 5 sets micro step driving sequence in which a phase signal has a time width divided into a plurality of widths beforehand.

During micro step driving, the phase controller 5 controls the driver 4 so that a value of current flowing through the stator coils 2 is finely controlled in a stepwise manner in accordance with the set micro step driving sequence.

Thereby, the driver 4 rotates/drives the rotor 3, while finely controlling the position of the rotor 3.

Therefore, during starting of the stepping motor 1, the phase controller 5 controls the driver 4 so that the value of current flowing through the stator coils 2 is finely controlled in a stepwise manner in accordance with the micro step driving sequence.

Thereby, for example, in a certain timing, the driver 4 changes a ratio of the value of the current flowing through the stator coils 2 in the phase A to the value of the current flowing through the stator coils 2 in the phase B and subtly changes the mechanical angle of the rotor 3 so as to perform micro step driving.

In the next timing, the driver 4 changes the ratio of the value of the current flowing through the stator coils 2 in the phase B to the value of the current flowing through the stator coils 2 in the phase C and subtly changes the mechanical angle of the rotor 3 to perform micro step driving.

In the next timing, the driver 4 changes the ratio of the value of the current flowing through the stator coils 2 in the phase C to the value of the current flowing through the stator coils 2 in the phase D and subtly changes the mechanical angle of the rotor 3 to perform micro step driving.

In the next timing, the driver 4 changes the ratio of the value of the current flowing through the stator coils 2 in the phase D to the value of the current flowing through the stator coils 2 in the phase A and subtly changes the mechanical angle of the rotor 3 to perform micro step driving.

The stepping motor 1 smoothly starts up in this manner, while finely controlling the position of the rotor 3.

During micro step driving, the stepping motor 1 rotates/drives the rotor 3, while finely controlling the position of the rotor 3. Therefore, the motor rotates without any large deviation of an electric angle and mechanical angle, and is not out-of-step.

When the rotation speed of the rotor 3 reaches the specific rotation speed, the phase controller 5 switches from micro step driving to 1-2 phase excitation driving.

That is, the phase controller 5 controls the driver 4 so that the driver 4 supplies the phase signals to the stator coils 2 as shown in FIG. 2.

After the stepping motor is switched to 1-2 phase excitation driving, the rotor 3 is rotated/driven at a constant speed with a high torque.

That is, the stepping motor 1 rotates/drives the rotor 3 with a lower rotation speed and a larger torque than conventional case.

Thereby, when the stepping motor 1 rotates/drives the rotor 3 at a constant speed, torque insufficiency is avoided and a deviation amount of the electric angle and mechanical angle is prevented from increasing.

In this manner, even during 1-2 phase excitation driving, the stepping motor 1 rotates without any large deviation of the electric angle and mechanical angle, and is not out-of-step.

Additionally, when the stepping motor 1 is used to move/control, for example, a carrier with a printing head mounted thereon, the rotation of the motor 1 is transmitted to a carrier via a pulley and belt.

In this case, if the diameter of the pulley is increased, the carrier moves at the same speed as the conventional case, even if the rotation speed of the motor 1 is reduced.

An operation for decelerating and stopping the stepping motor 1 rotated/driven at the constant speed will next be described.

In this case, the phase controller 5 controls the driver 4 to perform 1-2 phase excitation driving, until the rotation speed of the rotor 3 drops to the specific rotation speed.

When the rotation speed of the rotor 3 drops to the specific rotation speed, the phase controller 5 switches 1-2 phase excitation driving to micro step driving.

That is, the phase controller 5 controls the driver 4 so that the value of current flowing through the stator coils 2 is finely controlled in a stepwise manner in accordance with the set micro step driving sequence.

Thereby, for example, in a certain timing, the driver 4 changes the ratio of the value of the current flowing through the stator coils 2 in the phase A to the value of the current flowing through the stator coils 2 in the phase B and subtly changes the mechanical angle of the rotor 3 so as to perform micro step driving.

In the next timing, the driver 4 changes the ratio of the value of the current flowing through the stator coils 2 in the phase B to the value of the current flowing through the stator coils 2 in the phase C and subtly changes the mechanical angle of the rotor 3 to perform micro step driving.

In the next timing, the driver 4 changes the ratio of the value of the current flowing through the stator coils 2 in the phase C to the value of the current flowing through the stator coils 2 in the phase D and subtly changes the mechanical angle of the rotor 3 to perform micro step driving.

In the next timing, the driver 4 changes the ratio of the value of the current flowing through the stator coils 2 in the phase D to the value of the current flowing through the stator coils 2 in the phase A and subtly changes the mechanical angle of the rotor 3 to perform micro step driving.

The stepping motor 1 smoothly stops the rotor 3, while finely controlling the position of the rotor in this manner.

During micro step driving, the stepping motor 1 rotates without any large deviation of the electric angle and mechanical angle.

Therefore, in this case, similarly as during the starting, the stepping motor 1 is not out-of-step.

As described above, when the stepping motor 1 is started and accelerated to the specific rotation speed, and when the motor is decelerated from the specific rotation speed and stopped, micro step driving is performed. Therefore, during driving, the stepping motor 1 is prevented from being out-of-step.

Moreover, the stepping motor 1 rotates at a constant speed which is not less than the specific rotation speed, and the 1-2 phase excitation driving is performed. Additionally, since the speed is reduced and the torque is increased, the motor is prevented from being out-of-step because of insufficient torque.

Further, it is unnecessary to alter the design largely, namely to increase the torque of the stepping motor or to decrease the load on the motor. This suppresses the cost increase.

Additionally, in the above-described embodiment, the constant-speed rotation of the stepping motor 1 by 1-2 phase excitation driving has been described, but this is not limited.

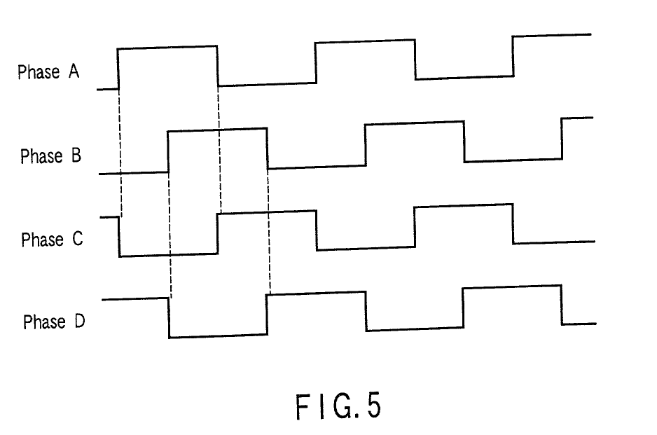

In another embodiment, for example, the phase signals of the phases A, B, C, and D are outputted in timings shown in FIG. 5, so that 2-phase excitation driving of the stepping motor 1 may be carried out.

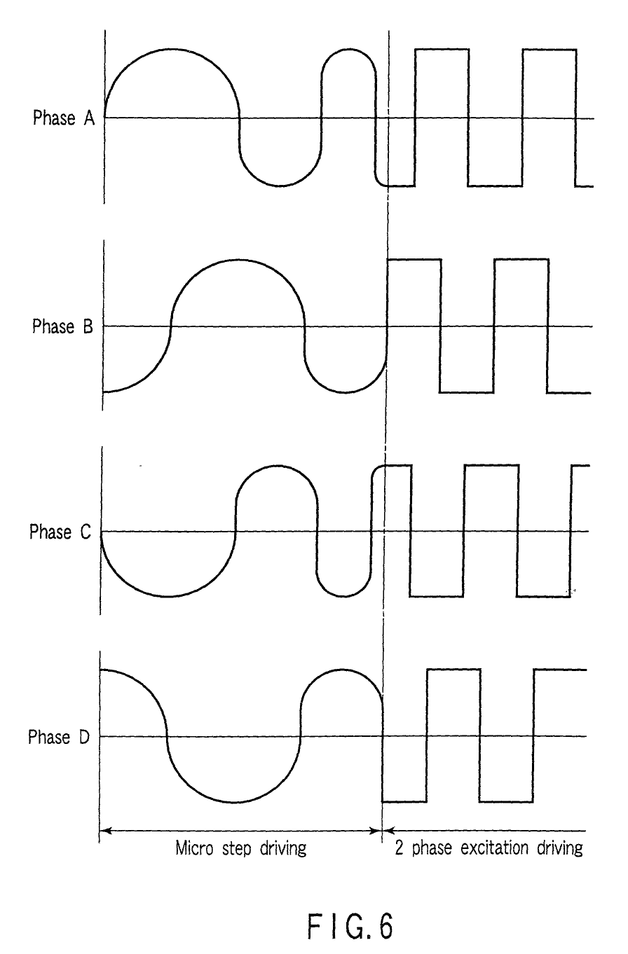

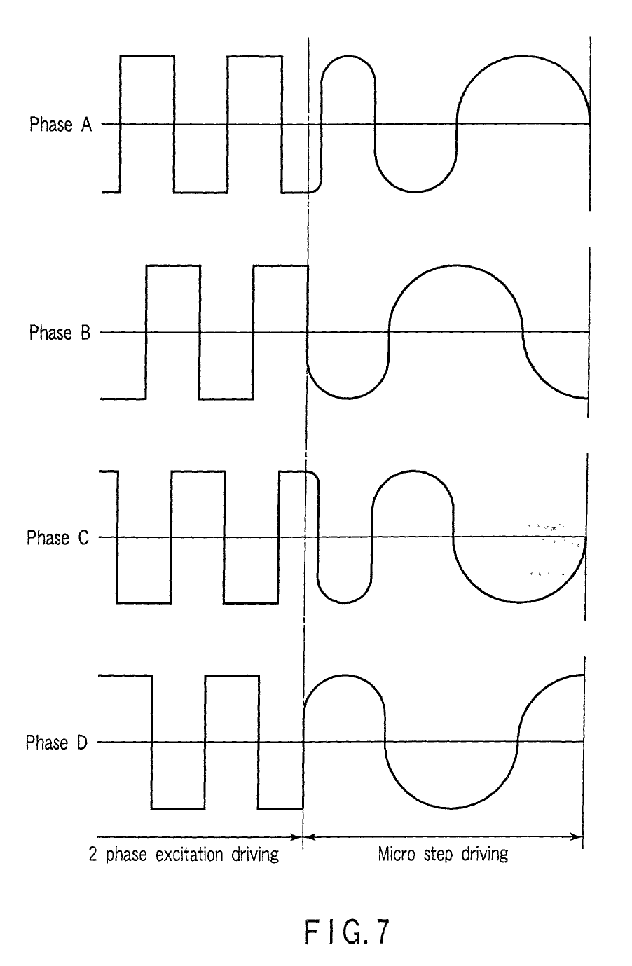

In this case, to start the stepping motor 1, as shown in FIG. 6, firstly, micro step driving is performed, and then switched to 2-phase excitation driving when the rotation speed of the rotor 3 rises to the specific speed.

Moreover, during decelerating and stopping of the stepping motor 1, as shown in FIG. 7, 2-phase excitation driving is performed until the rotation speed of the rotor 3 drops to the specific speed. Subsequently, when the rotation speed of the rotor 3 drops to the specific speed, the driving is switched to micro step driving.

Furthermore, in another embodiment, the stepping motor may be rotated at a constant speed by 1-phase excitation driving.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. A drive method for a stepping motor, comprising: rotating/driving a rotor rotating itself by a micro step in accordance with a micro step driving sequence with a plurality of divided phases from a rotation start until a rise of a rotation speed to a specific speed; and switching the rotating/driving of the rotor to rotating/driving of the rotor by phase excitation when the rotation speed rises to the specific speed.

2. The method according to claim 1, wherein the phase excitation is a 1-2 phase excitation.

3. The method according to claim 1, wherein the phase excitation is a 2 phase excitation.

4. A drive method for a stepping motor, comprising: switching the rotating/driving to a micro step driving sequence having a plurality of divided phases, when a rotation speed of said rotor drops to a specific speed, in order to decelerate and stop the rotor rotating at a constant speed by means of phase excitation.

5. The method according to claim 4, wherein the phase excitation is a 1-2 phase excitation.

6. The method according to claim 4, wherein the phase excitation is a 2 phase excitation.
